(19) United States
(12) Patent Application Publication
(10) Pub. No.: US 2016/0088557 A1
(43) Pub. Date: Mar. 24, 2016

(54) TIME SYNCHRONIZATION METHOD FOR ENERGY-EFFICIENT IN WIRELESS NETWORK AND NETWORK ADOPTING SAME

(71) Applicant: UNIVERSITY OF ULSAN FOUNDATION FOR INDUSTRY COOPERATION, Ulsan (KR)

(72) Inventors: Sung Oh Kwon, Seoul (KR); Wang Eun Lee, Ulsan (KR); Yoon Jin Kim, Busan (KR); Dong Gi Oh, Busan (KR)

(21) Appl. No.: 14/889,782

(22) PCT Filed: May 7, 2014
(86) PCT No.: PCT/KR2014/003992

§ 371 Date: Nov. 6, 2015

(30) Foreign Application Priority Data
May 7, 2013 (KR) 10-2013-0051519

(51) Int. Cl. H04W 52/02; H04W 56/00

(52) U.S. Cl. CPC H04W 52/0216; H04W 56/001; H04W 84/18

(57) ABSTRACT

The present disclosure relates to a time synchronization method for energy-efficient wireless network and a network adopting the same that operates time synchronization between sensor nodes using an alternating feature in a low power wireless network with a sleep mode. Accordingly, power consumption is minimized and energy efficiency is improved and accuracy of the time synchronization can be improved regardless of installment positions.

### TECHNICAL FIELD

The present disclosure relates to a wireless network, and more particularly a time synchronization method for high energy-efficiency of a wireless network that operates time synchronization among sensor nodes using alternating current (AC) feature in a low-power wireless network with a sleep mode applied.

### BACKGROUND

As well known, wireless network (hereinafter, referred to as WSN) is a sensor which forms a network. It is a technology that is in active research worldwide as ubiquitous paradigm is expanding that is people-oriented and can access the internet anytime and anywhere.

Such wireless network is formed with an independent device that uses a sensor node to monitor physical or environmental condition. The sensor node has a communication function through collecting physical data such as light, temperature, and humidity. In addition, the sensor node forms a sensor network with a base station which functions as a gateway.

In general, a sensor node is installed in a region that is difficult to access so changing or charging battery is difficult. Accordingly, it is important how long the network can be maintained with limited energy. Thus, low-power design is necessary to ensure the use of battery for long hours.

According to a feature of the sensor node that the sensor node is operated with a battery. In addition, changing the battery, and installing and removing the sensor node are difficult. Accordingly, power management design is important for a sensor node. Power consumption of a sensor node is the highest in case of idle radio listening.

To overcome high power consumption of a sensor node, a low-power design method is adopted which controls active time and sleep time through periodically turning on/off of a wireless communication unit, a processor, and a sensor of a sensor node. The entire sensor node needs to operate organically in this case because if any one of the node is not linked properly, not only would it be difficult to achieve low-power consumption but would be difficult to properly deliver a sensing data.

Accordingly, in case of designing for low-power consumption with the on/off operation, all nodes should be simultaneously on/off periodically and time synchronization and task scheduling should be controlled.

FIG. 1 is a diagram illustrating a wireless sensor network system using a conventional sensor node. Referring to FIG. 1, time synchronization process of a conventional sensor node is illustrated.

First, a plurality of sensor node 20 is disposed on a sink node 10, thereby communicates according to a predetermined route. The sink node 10 functions as a master node of sensor nodes 20.

FIG. 1 is a time synchronization method of a same type sensor node 20 that synchronize time of the entire sensor network nodes through periodically exchanging time synchronization information between each sensor node 20. Global time of the entire sensor network sensor node is determined based on an internal block of a sink node 10.

The wireless sensor network is formed with a plurality of sensor nodes 20 that is operated with a battery which periodically repeats active and sleep time to minimize battery operation.

In other words, in sleep time, power consumption is restrained in maximum by turning off the power of the sensor node 20. In active time, however, original functions such as sensing, data processing and wireless communication is operated through the sensor.

In addition, data is transmitted to the internet and server through the sink node 10 by this method. The data of each sensor node 20 should pass through other sensor nodes 20 in the way to be transmitted since a scope of wireless transmission is limited tens to hundreds of meters.

Accordingly, all sensor nodes 20 should operate active and sleep mode simultaneously. For this, accurate time synchronization of all sensor nodes 20 is necessary.

In conventional art, time synchronization method using Network Time Protocol (NTP) and Global Positioning System (GPS) was used for the afore-mentioned-like time synchronization.

Although, the time synchronization method using NTP according to the conventional art is proper for synchronizing computer time on the internet, it may not be proper in case of limited energy, a structure of concentration of many sensor nodes and exponential generation of data in a specific time may not be proper.

Further, time synchronization using GPS is capable of accurate time synchronization however; energy consumption and cost are high. Thus, efficiency is low in terms of cost to apply on a comparatively cheap sensor node and communication may be difficult in a blind spot such as in the building and under the ground or water.

### SUMMARY OF INVENTION

### Solution to Problem

The present disclosure provides a time synchronization method for energy-efficient wireless network and a network adopting thereof. The network uses an AC feature in a low-power wireless network applied with sleep mode thereby minimizes energy consumption through time synchronization among sensor nodes. In addition, it improves energy efficiency and at the same time, accuracy of time synchronization regardless of installment position.

Furthermore, the present disclosure provides a time synchronization method and a network using thereof for energy high efficiency in a wireless network that is applicable for time synchronization in a network base station or among nodes when AC voltage is applied from a wireless network such as a Femto cell network that operates distributed time synchronization.

### Technical Solutions

The present disclosure is directed to providing a time synchronization method for energy-efficient wireless network including, a) outputting a time synchronization instruction according to an alternating current (AC) voltage detected in a sink node; b) a sensor node configured to receive the time synchronization instruction that is output from the sink node, and to determine control of active time and sleep time included in the time synchronization instruction, and turns power operation on/off.

The a) may include a1) detecting the alternating current (AC) voltage; a2) counting a signal value of a predetermined period of the detected alternating voltage; a3) controlling an output of the time synchronization instruction according to the counted signal value; and a4) transmitting the time synchronization instruction to the sensor node.

The b) may include b1) receiving the time synchronization instruction; b2) controlling output of clock on/off signal by determining the control of active time and sleep time according to the received time synchronization instruction; b3) operating clock that selectively operates according to the clock on/off signal; and b4) transmitting data to a base station in the clock on-state.

The b4) may transmit and transfer time information with other sensor nodes in the clock on-state.

The b) further includes a timing for counting time, and outputs the clock on/off signal in case predetermined time is counted according to the timing.

Additionally, a network adopting the time synchronization method for energy-efficient wireless network includes a sink node configured to detect alternating current (AC) voltage and outputs a time synchronization instruction; and a sensor node configured to receive the time synchronization instruction that is outputted from the sink node and turns the operation power on/off by determining the control of active time and sleep time included in the time synchronization instruction.

The sink node may include a detector that detects the alternating current (AC) voltage; a counter configured to count a signal value of a predetermined period of the detected alternating current (AC) voltage; a controller configured to output a time synchronization instruction according to the counted signal value; and a transmitter configured to transmit the time synchronization instruction to the sensor node.

The sensor node may include a receiver configured to receive the time synchronization instruction, the controller configured to output clock on/off signal by determining control of the active time and sleep time according to the received time synchronization instruction, a clock configured to selectively operate according to the clock on/off signal, and a data communication unit configured to transmit data to a base station in the clock on-state.

The data communication unit is configured to receive and transmit the time information with other sensor nodes in the clock on-state.

The sensor node further includes a timer that counts time and the controller is configured to output the clock on/off signal in case predetermined time is counted by the timer.

### Effects of Invention

According to the exemplary embodiments of the present disclosure, a time synchronization method for energy high efficiency of a wireless network and a network adopting thereof operates time synchronization using alternating current feature in a low-power wireless network having a sleep mode applied thereto, thereby having an effect of minimizing power consumption and improves energy efficiency and accuracy of time synchronization regardless of installment position at the same time.

In addition, the exemplary embodiments of the present disclosure, a time synchronization method for energy high efficiency of a wireless network and a network adopting thereof can be applied to a time synchronization in a base station in a wireless network such as a Femto cell network, wireless sensor network, wireless machine communication network that can use or detect alternating current (AC) voltage.

### BRIEF DESCRIPTION OF THE DRAWINGS

FIG. 1 illustrates a diagram of a wireless sensor network using conventional sensor nodes.

FIG. 2 illustrates a flow chart of a time synchronization method for energy efficiency of a wireless network according to an exemplary embodiment of the present disclosure.

FIG. 3 illustrates a control flow chart of a sink node application according to a method according to exemplary embodiment of FIG. 2.

FIG. 4 illustrates a control flow chart of a sensor node application according to a method according to exemplary embodiment of FIG. 2.

FIG. 5 illustrates a block diagram of a network using a time synchronization method for energy efficiency in a wireless network according to an exemplary embodiment of the present disclosure.

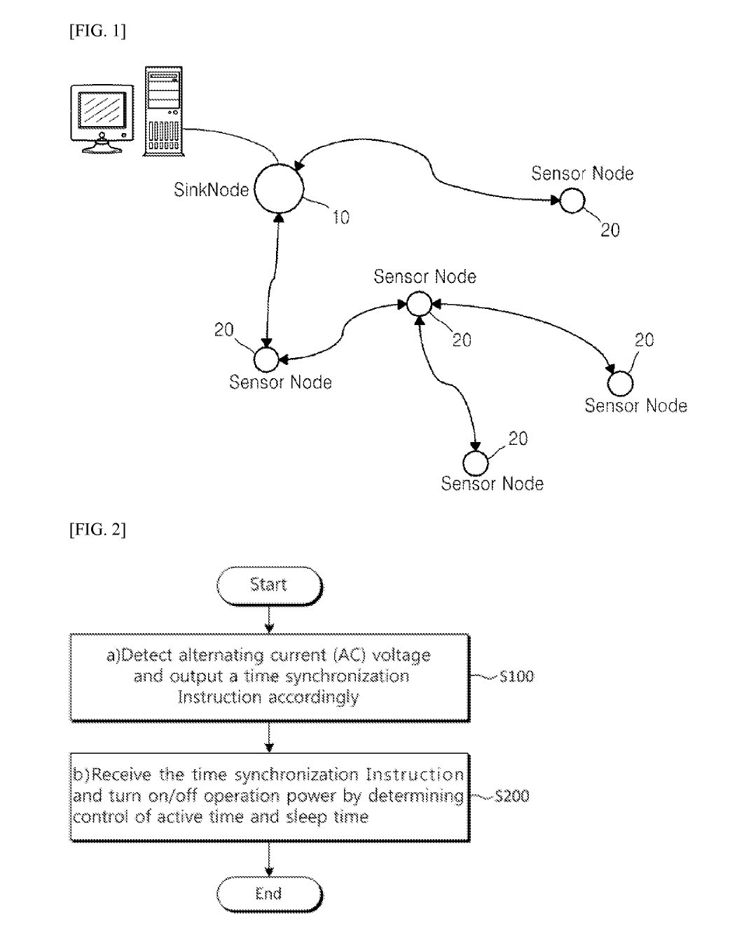

### METHOD FOR CARRYING OUT THE INVENTION

Certain exemplary embodiments of the present inventive concept will now be described in greater detail with reference to the accompanying drawings. In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

While the expressions such as “first” or “second” can be used to refer to various elements, the elements are not limited by the expressions. The expressions are used only for the purpose of distinguishing one element from the other.

The expressions are used herein only for the purpose of explaining specific embodiments and not to limit the present disclosure. An expression in singular form encompasses plural meaning, unless otherwise specified.

Throughout the description, the expression “comprise” or “have” is used only to designate the existence of characteristic, number, step, operation, element, component or a combination thereof which are described herein, but not to preclude possibility of existence of one or more of the other characteristics, numbers, steps, operations, elements, components or combinations of these or addition.

Spatial words in relative sense such as below, beneath, lower and above, upper can be used to easily illustrate the correlation between one element or feature and other elements or features as shown in the drawing. Spatial words in relative sense includes other direction of an element when used or operated with direction wherein shown in the drawing.

For example, element recited as below or beneath of another element can be above or upper of another element when overturning the element shown in the drawing. Accordingly, exemplary word, below can include both directions of below and above. Element can be aligned in a different direction, thereby, spatial word in a relative sense can be explained according to the aligned direction.

The present disclosure will be described more fully hereinafter with reference to the accompanying drawings, in which exemplary embodiments of the invention are shown.

The present disclosure is applicable to a wireless network in general such as Femto cell network, wireless sensor network, wireless machine communication network that can use or detect alternating current (AC) voltage however, an operation of the present disclosure according to an exemplary embodiment of the present disclosure is illustrated using a wireless sensor network.

FIG. 2 illustrates a flow chart of a time synchronization method for energy efficient wireless network according to an exemplary embodiment of the present disclosure.

A time synchronization method for energy efficient wireless network according to an embodiment of the present disclosure includes a) detecting AC voltage in a sink node and outputs a time synchronization instruction accordingly at step S100 and b) receiving a time synchronization instruction that is outputted from the sink node and the sensor node turns on/off the operation power by determining an active time and sleep time included in the time synchronization instruction at step S200.

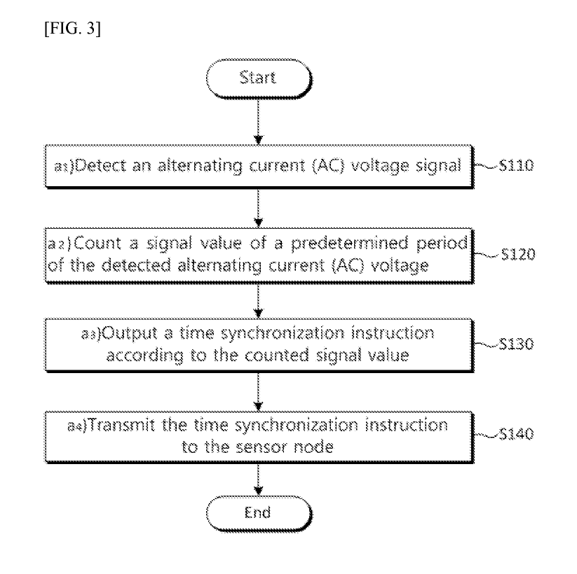

FIG. 3 illustrates a control flow chart of a sink node application according to a method according to exemplary embodiment of FIG. 2.

As illustrated, at the step S100, a) may include a1) detecting the alternating current (AC) voltage at step S110; a2) counting a signal value of a predetermined period of the detected alternating voltage at step S120; a3) controlling an output of the time synchronization instruction according to the counted signal value at step S130; and a4) transmitting the time synchronization instruction to the sensor node at step S140.

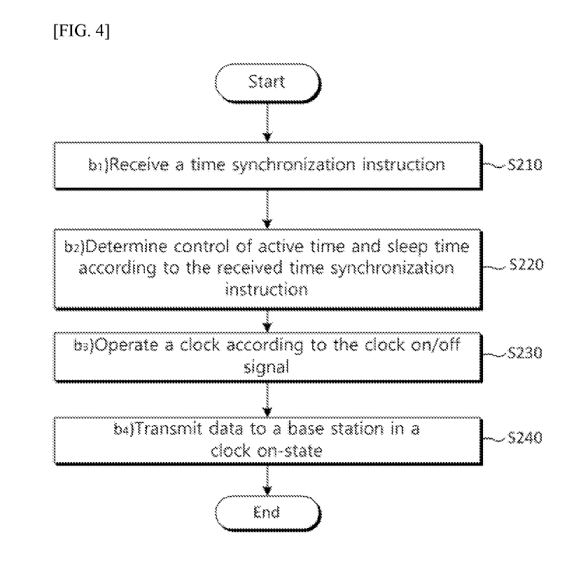

FIG. 4 illustrates a control flow chart of a sensor node application according to a method according to exemplary embodiment of FIG. 2.

As illustrated, the b) may include b1) receiving the time synchronization instruction at step S210; b2) controlling output of clock on/off signal by determining the control of active time and sleep time according to the received time synchronization instruction S220; b3) operating clock that selectively operates according to the clock on/off signal at step S230; and b4) transmitting data to a base station in the clock on-state at step S240.

Herein, the b4) at step S240 may transmit and transfer time information with other sensor nodes in the clock on-state.

Further, the b) further includes a step for timing that counts time and may output the clock on/off signal in case predetermined time is counted according to the timing at step S200.

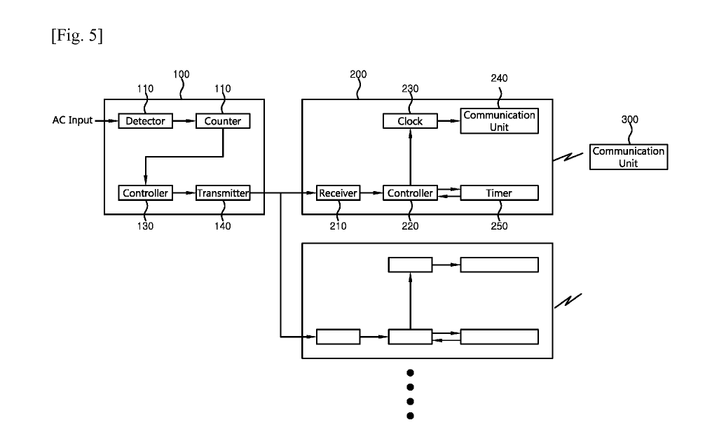

FIG. 5 illustrates a block diagram of a network using a time synchronization method for energy efficiency in a wireless network according to an exemplary embodiment of the present disclosure.

As illustrated, a network using a time synchronization method for energy efficiency in a wireless network according to an exemplary embodiment of the present disclosure includes a sink node 100 configured to detect alternating current (AC) voltage and outputs a time synchronization instruction accordingly; and a sensor node 200 configured to receive the time synchronization instruction that is output from the sink node 100 according to the detected alternating current (AC) voltage and turning on/off the operating power by determining control of the active time and sleep time included in the time synchronization instruction.

Herein, the entire sensor nodes 200 connected to the sink node 100 can be operated with a battery. Further, the present disclosure provides a sensor network connected in a wireless communication method however, the present disclosure does not limit to the wireless method. In addition, the sink node 100 and sensor nodes 200 is within at least one radio transmission range.

The sink node 100 includes a detector 110 configured to detect the alternating current (AC) voltage; a counter 120 configured to count a signal value of a predetermined period of the detected alternating current (AC) voltage; a controller 130 configured to output the time synchronization instruction according to the counted signal value; and a transmitter 140 configured to transmit the time synchronization instruction to the sensor node 200.

The sensor node 200 includes a receiver 210 configured to receive the time synchronization instruction; a controller 220 configured to output a clock on/off signal by determining control of an active time and sleep time according to the received time synchronization instruction; a clock 230 configured to selectively operate according to the clock on/off signal; and a data communication unit 240 configured to transmit a data to a base station 300 in the clock on-state.

The data communication unit 240 can transmit and receive the time synchronization information with other sensor nodes in the clock on-state.

Additionally, the sensor node 200 further includes a timer 250 configured to count a time, and the controller 220 is configured to output the clock on/off signal in case a predetermined time is counted by the timer 250.

### BEST MODE FOR CARRYING OUT THE INVENTION

As those skilled in the art would realize, the described embodiments may be modified in various different ways, all without departing from the spirit or scope of the present disclosure.

First, detect an alternating current (AC) voltage from the sink node 100 and output a time synchronization instruction accordingly.

Herein, the detector 110 of the sink node 100 is configured to detect the input alternating current (AC) voltage.

For example, the frequency is 60 Hz and when there is an alternating current (AC) voltage waveform referred to as s(t) which has a period s, the detector 110 detects the alternating current (AC) voltage in every point of s(t)=0 and informs to the controller 130 at step S110.

Hereinafter, the counter 120 is configured to count a signal value of a predetermined period of the alternating current voltage and the controller unit 130 outputs the time synchronization instruction according to the counted signal value at step S120 to S130.

Then, the receiver 140 transmits the time synchronization instruction to the sensor node 200.

In addition, the sensor node 200 receives the time synchronization instruction that is outputted from the sink node 100 and turns an operation power by determining a control of the active time and sleep time included in the time synchronization instruction.

Herein, the receiver 210 of the sensor node receives the time synchronization instruction and the controller 220 outputs clock on/off signal by determining the control of the active time and sleep time according to the received time synchronization instruction at step S210 to S220.

Hereinafter, the clock 230 is selectively operated according to the clock on/off signal, a data communication unit 240 transmits a data to the base station 300 in the clock on-state.

Herein, the data communication unit 240 may receive and transmit the time information with other sensor nodes in the clock on-state.

Further, the sensor node 200 may further include the timer 250 configured to count the time and the controller 220 may output the clock on/off signal in case a predetermined time is counted.

Accordingly, according to an exemplary embodiment of the present disclosure, a low power wireless network with a sleep mode applied implements time synchronization using an alternating current (AC) feature. Thereby, minimizes power consumption and improves energy efficiency and improves accuracy of the time synchronization regardless of an installment position at the same time.

Further, features of the present disclosure may be applicable to a time synchronization of a wireless network such as a Femto cell network for distributed time synchronization.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the scope of the present disclosure shall be determined only according to the attached claims.

### INDUSTRIAL APPLICABILITY

The present disclosure provides a time synchronization method for energy-efficient wireless network and a network thereof that is applicable not only in a low-power wireless network applied with a sleep mode but also in a wireless network such as a Femto cell network for distributed time synchronization. In addition, it is also applicable to time synchronization among nodes or a base station of a wireless network such as Femto cell network, a wireless sensor network, wireless machine communication network that can use or detect alternating current (AC) voltage.

What is claimed is:

1. A time synchronization method for energy-efficient wireless network comprising:
a) outputting time synchronization instruction according to an alternating current (AC) voltage detected in a sink node;
b) a sensor node,
receiving time synchronization instruction that is output from the sink node,
determining control of active time and sleep time included in the time synchronization instruction, and
turns on/off power operation.

2. The time synchronization method for energy-efficient wireless network of claim 1, wherein,
said a) comprising,
a1) detecting the alternating voltage;
a2) counting a signal value of a predetermined period of the detected alternating voltage;
a3) controlling an output of the time synchronization instruction according to the counted signal value; and
a4) transmitting the time synchronization instruction to the sensor node.

3. The time synchronization method for energy-efficient wireless network of claim 1, wherein,
said b)
b1) receiving the time synchronization instruction;
b2) controlling output of clock on/off signal by determining the control of active time and sleep time according to the received time synchronization instruction;
b3) operating clock that selectively operates according to the clock on/off signal; and,
b4) transmitting data to a base station in the clock on-state.

4. The time synchronization method for energy-efficient wireless network of claim 3, wherein
the b4)
transmitting and transferring time information with other sensor nodes in the clock on-state.

5. The time synchronization method for energy-efficient wireless network of claim 3, wherein
the b) further comprising a timing that counts time, and outputs the clock on/off signal in case predetermined time is counted according to the timing.

6. A network adopting the time synchronization method for energy-efficient wireless network comprising:
a sink node that detects alternating current (AC) voltage and outputs time synchronization instruction; and
a sensor node that receives the time synchronization instruction according to detected alternating current (AC) voltage and turning on/off the operating power by determining control of the active time and sleep time included in the time synchronization instruction.

7. The network adopting the time synchronization method for energy-efficient wireless network of claim 6, wherein
the sink node comprising a detector that detects the alternating current (AC) voltage;
a counter that counts a signal value of a predetermined period of the detected alternating current (AC) voltage;
a controller that outputs time synchronization instruction according to the counted signal value; and
a transmitter that transmits the time synchronization instruction to the sensor node.

8. The network adopting the time synchronization method for energy-efficient wireless network of claim 6, wherein
the sensor node comprises
a receiver that receives the time synchronization instruction,
the controller that outputs clock on/off signal by determining control of the active time and sleep time according to the received time synchronization instruction,
a clock that selectively operates according to the clock on/off signal, and
a data communication unit that transmits data to a base station in the clock on-state.

9. The network adopting the time synchronization method for energy-efficient wireless network of claim 8, wherein
the data communication unit receives and transmits the time information with other sensor nodes in the clock on-state.

10. The network adopting the time synchronization method for energy-efficient wireless network of claim 6, wherein
the sensor node further comprises a timer that counts time and,
the controller outputs the clock on/off signal in case predetermined time is counted by the timer.
